(19) United States
(12) Patent Application Publication
(10) Pub. No.: US 2021/0161095 A1
(43) Pub. Date: Jun. 3, 2021

(54) COOLING SYSTEM FOR COOLING DAIRY ANIMALS

(71) Applicant: DELAVAL HOLDING AB, Tumba (SE)

(72) Inventor: Boris PEROVIC, Tumba (SE)

(73) Assignee: DeLaval Holding AB, Tumba (SE)

(21) Appl. No.: 17/044,975

(22) PCT Filed: Apr. 2, 2019
(86) PCT No.: PCT/SE2019/050298

§ 371 Date: Oct. 2, 2020

(30) Foreign Application Priority Data
Apr. 5, 2018 (SE) 1850383-9

(51) Int. Cl. A01K 1/00; A01K 1/10

(52) U.S. Cl. CPC A01K 1/0082; A01K 1/10

(57) ABSTRACT

A cooling system (100) for cooling dairy animals (1) a feed front (110) wherein the cooling system (100) comprises a plurality of cooling zones (120.n) and cooling means (10.n,20.n) arranged to provide cooling fluid into the plurality of cooling zones (120.n), and a sensor means (3; 30.n,40.n) arranged to detect the presence of a dairy animal (1) in each cooling zone (120.n), and a controller (60) for controlling the cooling means (10.n, 20.n) and arranged to receive sensor signal input from the sensor means (3; 30.n,40.n) and, based on sensor signal input indicative of the presence of a dairy animal (1) in a cooling zone (120.n), to activate the cooling means (10.n, 20.n) to provide cooling fluid into said cooling zone (120.n).

### TECHNICAL FIELD

The present disclosure relates to a cooling system for cooling dairy animals at a feed front. The present disclosure also relates to milking facility having a cooling system for cooling dairy animals at the feed front. The present disclosure further relates to method for operating a cooling system for cooling dairy animals standing at a feed front.

### BACKGROUND ART

Heat stress (i.e. hyperthermia) in dairy animals such as cows is a general problem within the dairy industry. Heat stress occurs when a dairy animal's heat load is greater than her capacity to lose heat. Heat stress will generate milk production losses for the farmer and other health problems for the dairy animals (e.g., decreased reproductive efficiency). In recent times it has become increasingly important to address heat stress within the dairy industry. One reason is the higher ambient temperatures caused by climate change. Another is the increased use of high yielding dairy animals which themselves generate large amounts of heat that needs to be dissipated.

To reduce the risk of heat stress it may be necessary to cool the dairy animals. One solution is indirect cooling of the ambient air of the barn. Another solution is direct cooling of the dairy animals. In direct cooling, water droplets are sprayed over the dairy animal and simultaneously air is blown onto the dairy animal to assist in evaporation of the water and produce a cooling effect.

Cooling of the dairy animals may be performed at the feed front in the feeding area, where the dairy animals are located during feeding. The feed front may be in the form of a feed fence where dairy animals may be locked to the feed fence to ensure that they receive cooling treatment for a sufficient period of time. A problem with this approach is that a lot of manual work is demanded from the farmer to force the dairy animals to the feeding area, lock the dairy animals at the feed fence and keep them locked for some time to receive cooling treatment.

In AMS farms (Automatic Milking System), where the dairy animals are milked using a milking robot, the conventional cooling approach cause further drawbacks. In an AMS farm each dairy animal is habituated to visit the AMS with regular intervals and to voluntarily move between the AMS, the feeding area and the resting area. However, as long as the dairy animals are locked to the feed fence in the feeding area for cooling none of the dairy animals can visit the AMS which of course is inefficient use of the AMS. Moreover, when all the dairy animals are released at the same time from the feed fence, many or all of the dairy animals may choose to go directly to the AMS for milking with the result that a queue of waiting dairy animals forms at the AMS. In AMS-farms queues or groups of waiting dairy animals should typically be avoided since it may obstruct the traffic of dairy animals in the barn. Queues or groups of waiting dairy animals may also result in discontinuous flow of dairy animals through the AMS resulting in reduced productivity of the milking system.

Attempts have been made to provide other cooling approaches in VMS farms. For example in EP1119238B1 is described that direct cooling may be provided in the milking robot. However, a problem with this approach is that the dairy animal, in need of cooling, may stay too long in the milking robot which in turn reduces the milking capacity of the farm. Also the cooling is limited to one animal at the time, and the cooling of each animal may be insufficient to avoid heat stress.

U.S. Pat. No. 4,987,861 describes another approach in which spray nozzles are arranged around an entrance way in a barn and spray cooling liquid on a cow passing through the entrance way. A problem with this approach is that a que of cows may form due to that the cows stop in the entrance way to get cooled, or that the animals are insufficiently cooled.

Thus, it is an object of the present disclosure to provide a cooling system for cooling dairy animals that solves at least one of the problems of the prior art. In particular it is an object of the present disclosure to provide a cooling system for cooling dairy animals which allows for efficient cooling of dairy animals with a minimum of manual labor. Yet a further object of the present disclosure is to provide a cooling system for cooling dairy animals which allows for efficient cooling of dairy animals at low operational cost and with a low consumption of cooling liquid, e.g. water.

### SUMMARY OF THE DISCLOSURE

According to the present disclosure, at least one of these objects is achieved by a cooling system for cooling dairy animals at a feed front having a plurality of feeding positions for dairy animals, said cooling system comprising a plurality of cooling devices configured to provide cooling fluid onto dairy animals standing at the feed front. The cooling fluid may be liquid such as water and/or gas such as air. The cooling system comprises a plurality of cooling zones, wherein each cooling zone has a length along the feed front, said length corresponding to a plurality of feeding positions of the feed front. The length of each cooling zone may be the same or different among the plurality of cooling zones. The plurality of cooling devices is arranged to provide cooling fluid into the plurality of cooling zones. At least one sensor arrangement is arranged to detect the presence of a dairy animal in in at least one of the plurality of cooling zones, and output a sensor signal indicative thereof. A controller is arranged to control the cooling devices and to receive sensor signal input from the sensor arrangement and, based on sensor signal input indicative of the presence of a dairy animal in at least one of the plurality of cooling zones, to activate the cooling devices to provide cooling fluid into said cooling zone.

The cooling system according to the present disclosure provides several advantages. Since the cooling system automatically starts a cooling procedure when a dairy animal walks into a cooling zone, the dairy animals learn fast that they will receive cooling at the feed front whenever they are in need thereof. Thus, the dairy animals will relatively soon start to go voluntarily to the feed front when they are in need of cooling. This has a positive impact on the traffic in the dairy barn since ques or grouping of animals is avoided. In addition, the dairy animals will spend more time at the feed front, where they apart from getting cooling also feed for longer periods. The cooling system according to the present disclosure further provides effective cooling of the dairy animals at a low water and power consumption. This since the cooling means only are run in cooling zones where dairy animals are present.

Preferably, each cooling device comprises at least one air blowing device and at least one liquid dispenser for cooling liquid, e.g. water. The liquid dispenser may thereby be arranged such that liquid is dispensed onto at least a portion to be wetted of a dairy animal in a cooling zone, and the air blowing device may be arranged such that a flow of air may be directed towards the wetted portion of the dairy animal. Thereby is high evaporation rate of the cooling liquid on the wetted portion of the animal achieved. This in turn results in an effective cooling of the animal.

The air blowing device may be arranged adjacent one end of each cooling zone and the liquid dispenser may be arranged between the air blowing device and the other end of each cooling zone. This is a simple but effective way of achieving a high evaporation rate of liquid dispensed onto dairy animals by the liquid dispensers. Typically each cooling device may thereby comprise a plurality of liquid dispensers distributed over the length of each cooling zone. Efficient cooling will thereby be provided over the full length of the cooling zone. Another advantage in this context is that only one air blowing device is needed per cooling zone.

Preferably, the sensor arrangement is configured to detect the presence of a head of a dairy animal extending through the feed front (e.g. feed fence). This may indicate that the dairy animal has started to feed and thus may stay at the feed front for sufficient time to benefit from a full cooling procedure, i.e. a full cooling cycle.

Preferably, the sensor arrangement may comprise a plurality of sensors; wherein each cooling zone comprises at least one sensor. Each sensor may thereby comprises a light emitter configured to be arranged at one end of each cooling zone and a light detector configured to be arranged at the other end of each cooling zone. An individual sensor comprising a light emitter and a light detector in each cooling zone is a simple, yet effective way of detecting the presence of a dairy animal in each cooling zone. The light emitter/light detector is suitable since it is a simple and low cost non-contact sensor which is robust and less apt to be broken by the dairy animals.

In an embodiment the sensor arrangement is a transponder/reader arrangement where one or more readers at the feed front is arranged to detect the presence of a transponder carried by the dairy animal, in a cooling zone. The advantage is that larger farms may already employ a transponder system for animal identification. Further, it may also allow for detection of specific individuals which in turn may allow for provision of cooling procedures that are tailored for specific animals.

In an embodiment, the sensor arrangement is an imaging system and comprises at least one camera arranged to record images of one or more cooling zones and/or the feed front. The advantage of an imaging system is its non-contact nature. However, further advantages of the imaging system are that it is more versatile and for example may allow for detection of dairy animals in a larger area of the feed zone than just at the feed front. It may also allow for detection of specific individuals which in turn may allow for provision of cooling procedures that are tailored for specific animals.

The plurality of cooling zones may be arranged adjacent each other along the feed front. Thereby a dairy animal will receive cooling along the extent of the feed front in the feeding area.

The present disclosure further relates to a controller for controlling a plurality of cooling devices arranged to provide cooling fluid into a plurality of cooling zones at a feed front. Each cooling zone has a length along the feed front, said length corresponding to a plurality of feeding positions for dairy animals at the feed front. The controller is arranged to receive sensor signal input from a sensor arrangement and, based on sensor signal input indicative of the presence of a dairy animal in at least one of the plurality of cooling zones, to output a signal to activate at least one of the plurality of cooling devices to provide cooling fluid into said cooling zone.

The present disclosure further relates to a milking facility comprising a milking system and a feeding area comprising a feed front having a plurality of feeding positions for dairy animals wherein the feed front comprises a cooling system for cooling dairy animals according to the present disclosure. The milking facility allows for high productivity of milk. Preferably, the milking system is an Automatic Milking System.

The present disclosure also relates to a method for operating a cooling system according to the present disclosure comprising the steps: receiving sensor signal input indicative of the presence of a dairy animal in said cooling zone and, activating, based on the sensor signal input, cooling means to provide cooling fluid in said cooling zone. Preferably the method comprises the step of initiating a predetermined cooling procedure comprising: operating the cooling devices to continuously provide an air flow and simultaneously dispense cooling liquid intermittently. The cooling procedure provides high cooling effect with optimized consumption of cooling liquid and energy.

### BRIEF DESCRIPTION OF THE DRAWINGS

FIG. 1: A schematic layout of a milking facility comprising a cooling system according to the present disclosure.

FIG. 2: A flowchart showing the steps of a method for operating the cooling system according to the present disclosure.

### DETAILED DESCRIPTION OF EMBODIMENTS

The cooling system for cooling dairy animals according to the present disclosure will now be described more fully hereinafter. The cooling system for cooling dairy animals according to the present disclosure may however be embodied in many different forms and should not be construed as limited to the embodiment set forth herein. Rather, this embodiment is provided by way of example so that this disclosure will be thorough and complete, and will fully convey the scope of the present disclosure to those persons skilled in the art. In the following description, the cooling system for cooling dairy animals may where appropriate be denominated “the cooling system”.

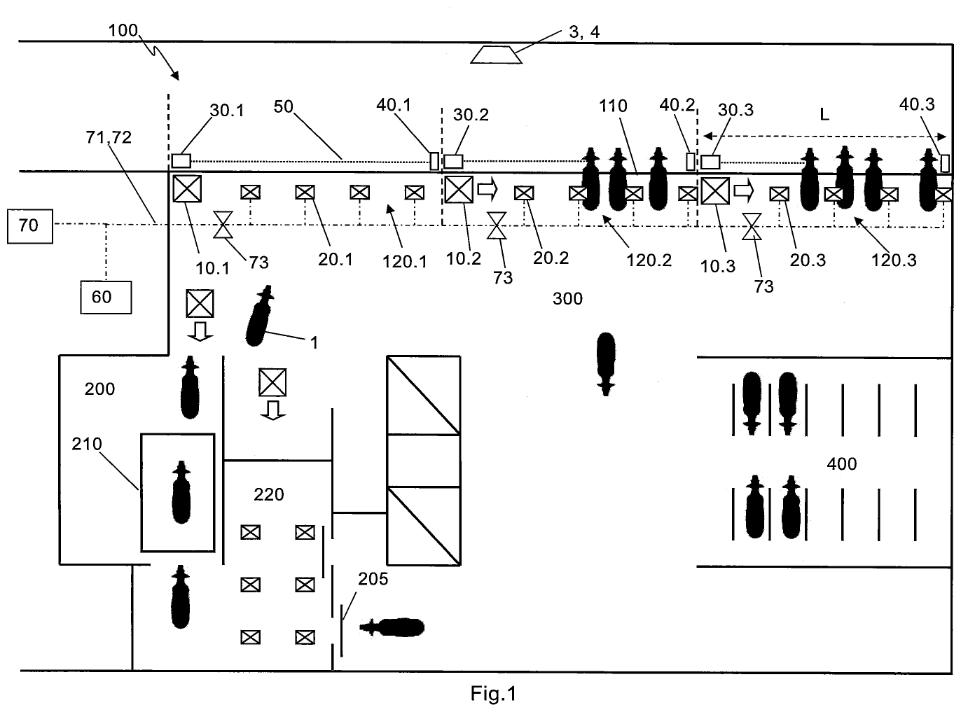

FIG. 1 shows schematically the layout of a milking facility for dairy animals 1. In this case the dairy animals are cows. However, the dairy animals may also be buffalos, goats or any other animal that is suitable for milk production.

The milking facility, which typically is located in a building such as a barn, comprises a milking area 200 with a milking system 210 and a waiting area 220 for accommodating dairy animals 1 that are waiting for access to the milking system 210. The waiting area 220 comprises doors 205 that may open automatically when approached by a dairy animal 1 that is scheduled for milking. The milking system 210 is accessible from the waiting area 220 so that a dairy animal 1 that is scheduled for milking may reside in the waiting area 220 until the milking system 210 becomes vacant. This provides for short idle periods of the milking system 210. The milking system 210 may for example be an Automatic Milking System (AMS), such as a DeLaval VMS™ which is commercially available from the company DeLaval International AB. In the AMS, milking of the dairy animal is performed fully automatic and essentially without human interaction. When a dairy animal enters the AMS, the location of the teats of the animal are detected, the teats are cleaned, teat cups are attached by a robotic arm and the milking begins. After milking the dairy animal is released and the AMS is cleaned. The specific features of the AMS are known in the art and not depicted in FIG. 1.

The milking facility further comprises a resting area 400 where the dairy animals may sleep and ruminate, and a feeding area 300 with a feed front 110 where the animals are fed.

The feed front 110 provides a barrier for the dairy animals 1 such that the dairy animals 1 remain in the feeding area 300 on one side of the feed front 110 but have access to feed on the other side of feed front 110. The feed front 110 may thereby comprise openings (not shown) that allows the dairy animal to pass the head through the feed front 110 in order to reach the feed on the other side of the feed front 110. According to one alternative, the feed front 110 may be a feed fence which may allow for locking the dairy animals at the feed fence. Alternatively, the feed front 110 may be a feed rail, which constrains the dairy animals to reside on one side of the feed rail but typically is not configured for locking the dairy animals. The feed front 110 has a plurality of feeding positions for dairy animals. A feeding position may be defined by the length of the feed front that one dairy animal occupies when the dairy animal is standing at the feed front and feeds. Thus, the number of feeding positions of the feed front 10 may be equal to the number of dairy animals 1 that at the same time may stand side-by-side at the feed front 110 and feed. In the case where the feed front 110 comprises discrete openings for the heads of the dairy animals, one opening in the feed front 110 may define one feeding position.

In the milking facility, the dairy animals 1 may walk freely between the resting area 400, the feeding area 300 and the milking area 200. Alternatively the animals are guided via gates allowing selection and separation of animals, e.g. for milking.

In the following description reference is made to features of the cooling system 100 such as cooling devices 10.n, 20.n; sensor arrangement 3, 30.n, 40.n and cooling zones 120.n. In the embodiment shown in FIG. 1, the cooling devices 10.n, 20.n and the sensor arrangement 3, 30.n, 40.n are associated with specific cooling zones 120.n and therefore, for purpose of clarity, these features may where appropriate be denominated with specific ordinal numbers, such as cooling zones 120.1-120.3, cooling devices 10.1-10.3; 20.1-20.3 and sensors 30.1-30.3; 40.1-40.3 of the sensor arrangement 3, 30.n, 40.n. However, where e.g. merely characteristics of these features are described the specific ordinal number may be omitted to not burden the text unnecessarily.

The milking facility comprises a cooling system 100 for cooling dairy animals. The cooling system 100 is configured to be arranged along the feed front 110. Thus, in operation, as shown in FIG. 1, the cooling system 100 extends along at least a portion of the feed front 100. The cooling system 100 comprises a plurality of cooling devices 10.n, 20.n for providing cooling fluid onto the dairy animals 1 standing at the feed front 110. The cooling fluid may be air or liquid (typically water) or combinations thereof. Each cooling device 10.n, 20.n may for example comprise at least one air blowing device 10.n and at least one liquid dispenser 20.n. The air blowing device 10.n is configured to provide an air flow towards the dairy animals standing at the feed front 110. For example, the air blowing device 10.n is a fan, however it may also be a duct that leads an airflow from a remote source (not shown). The liquid dispenser 20.n is preferably configured to dispense a shower of liquid droplets. The liquid dispenser 20.n may thus be a liquid sprayer, such as a sprinkler. The liquid may be supplied to the liquid dispenser 20.n from a liquid-source 70 via a liquid-line 71. In operation, the liquid dispenser is arranged to dispense liquid onto one or more dairy animals at the feed front 110 such that at least a portion of the dairy animal is wetted. Typically, the liquid dispenser 20.n is arranged to wet at least the back and the shoulders of the dairy animal. The liquid dispenser 20.n is therefore preferably arranged above the back of the dairy animals 1 standing at the feed front 110. The air blowing device 10.n is arranged such that the airflow from the air blowing device 10.n is directed towards the wetted portion of the dairy animal. The airflow increases the evaporation rate of the liquid on the wetted portion of the dairy animal and achieves thus an efficient cooling of the dairy animal. According to one alternative the air blowing device comprises also a liquid dispenser, i.e. a misting fan, configured to provide a mist of liquid droplets with the air.

Examples of liquid dispensers 20.n are Wide Angle Turbo FloodJet from the company TeeJet. An example of an air blowing device 10.n is a DeLaval dairy fan DDF1200P/S from the company DeLaval International AB.

According to the present disclosure, the cooling system 100 comprises a plurality of cooling zones 120.n. Each cooling zone 120.n extends along a section of the feed front 110 and has a length L which corresponds to a plurality of feeding positions along the feed front 110. Each cooling zone 120.n may thus comprise at least two feeding positions, however for economic reasons each cooling zone 120.n preferably comprise more than two feeding positions, for example three or more feeding position. For example, 3-10 feeding positions. It is appreciated that the plurality of cooling zones 120.n of the cooling system 100 may have the same or different number of feeding positions. The number of cooling zones 120.n may also vary. For example the cooling system 100 may comprise at least two cooling zones 120.n. However, typically, the number of cooling zones depends on the length of the feed front 110. The cooling zones 120.n may thereby be arranged adjacent each other along the length of the feed front 110. For example, as shown in FIG. 1, the cooling system 100 comprises three cooling zones 120.1, 120.2, 120.3 arranged adjacent each other along the feed front 110.

The cooling zones 120.n may be defined by physical means which indicate the beginning and the end of a cooling zone. However, it is also possible that each cooling zone 120.n is merely defined as a predetermined length L at a predetermined position along the feed front 110. An example of such an embodiment will be described at the end of this description.

The cooling devices 10.n, 20.n are arranged such that each cooling zone 120.n may be provided with cooling fluid. Preferably, the cooling devices 10.n, 20.n are thereby arranged such that cooling fluid may be provided into each cooling zone 120.n by at least one cooling device 10.n, 20.n. The plurality of cooling devices 10.n, 20.n may thereby be arranged such that one cooling device 10.n, 20.n may provide cooling fluid into one cooling zone 120.n. Or such that one cooling device 10.n, 20.n may provide cooling fluid into more than one cooling zones 120.n.

In the embodiment shown in FIG. 1, at least one cooling device 10.n, 20.n is provided for each cooling zone 120.n. Thus, a first cooling device 10.1, 20.1 is provided for cooling zone 120.1. A second cooling device 10.2, 20.2 is provided for cooling zone 120.2 and a third cooling device 10.3, 20.30 is provided for cooling zone 120.3. Each cooling device 10.n, 20.n comprises at least one air blowing device 10.n which is arranged to blow an airflow into the cooling zone 120.n associated with said cooling device 10.n, 20.n. In addition, each cooling device 10.n, 20.n comprises at least one liquid dispenser 20.n which is arranged to dispense liquid onto dairy animals 1 standing in the cooling zone 120.n associated with said cooling device 120.n. In the embodiment shown in FIG. 1, each cooling device 10.n, 20.n comprises a plurality of liquid dispensers 20.n which may be distributed over the length L of each cooling zone 120.n associated with said cooling device 10.n, 20.n.

Each air blowing device 10.n may be arranged adjacent one end of each cooling zone 120.n and the liquid dispensers 20.n may be arranged between the air blowing device 10.n and the other end of each cooling zone 120.n. By this arrangement, one air blowing device 10.n suffices to facilitate evaporation of the liquid dispensed onto the dairy animals in each cooling zone 120.n. The liquid dispenser 20.n, or the plurality of liquid dispensers 20.n of each cooling zone 120.n, are connected to a control device 73 that is configured to switch the liquid dispenser 20.n, or the plurality of liquid dispensers 20.n, of each cooling zone 120.n between an open-state, and a closed-state independently of the liquid dispenser/s 20.n of the other cooling zones 120.n. In the open state, liquid is dispensed from the liquid dispenser/s 20.n. In the embodiment of FIG. 1, the control device 73 may be one or more controllable on-off valves, for example solenoid valves, that are connected to a portion of the liquid line 71 leading to the liquid dispenser/s 20.n of each cooling zone 120.n. To allow for independent liquid provision, it is appreciated that the liquid line 71 may be designed with appropriate branch lines and by-pass lines (not shown), as is known by the skilled person.

The cooling system 100 further comprises at least one sensor arrangement 3, 30.n, 40.n which is configured to detect the presence of a diary animal in one of the plurality of (or each of) the cooling zones 120.n and to output a signal indicative thereof. The sensor arrangement 3, 30.n, 40.n may thus detect the presence of a dairy animal in one, or some, or all of the cooling zones 120.n.

According to one embodiment, as shown in FIG. 1, the sensor arrangement 3, 30.n, 40.n comprises a plurality of sensors 30.n, 40.n whereby at least one sensor 30.n, 40.n may be arranged in each cooling zone 120.n to detect the presence of a dairy animal in said cooling zone 120.n. In the described embodiment each sensor 30.n, 40.n comprises a light emitter 30.n and a light detector 40.n. The light emitter 30.n, which may be a laser or a Light Emitting Diode (LED), is arranged at one end of each cooling zone 120.n and the light detector 40.n, which may be a photovoltaic cell, is arranged at the other end of each cooling zone 120.n. For example, the light detector is an O4E500 from the company lmf electronics GmbH. Thus, the light emitter 30.n and the light receiver 40.n define the length L of a cooling zone 120.n. In operation, a light beam 50 is emitted from the light emitter 30.n towards the light detector 40.n. The light emitter 30.n and the light detector 40.n of each cooling zone 120.n are arranged such that the light beam 50 is interrupted when a dairy animal passes the head through the feed front 110.

Further according to the present disclosure, the cooling system 100 comprises a controller 60 for controlling the cooling means 10.n, 20.n.

The controller 60 may be implemented using a Programmable Logic Controller (PLC) or any suitable available processor that enable hardware functionality and a computer readable storage medium, such as memory that carry instructions to be executed by the processor or the PLC.

The controller 60 is connected to the sensor arrangement 3, 30.n, 40.n and to the cooling devices 10.n, 20.n. In the embodiment shown in FIG. 1, the controller 60 may thereby be electrically connected to the light detector 40.n of the sensor 30.n, 40.n of each cooling zone 120.n and to the fan 10 and to the controllable on/off valve 73 of the liquid dispensers 20 via an electrical wire 72.

The controller 60 is configured to receive sensor signal input from the sensor arrangement 3, 30.n, 40.n indicative of the presence of the dairy animal in a cooling zone 120.n. In the described embodiment, the light detector 40.n of the sensor 30.n, 40.n of each cooling zone 120.n senses whether light 50 from the light emitter 30.n is received on the light detector 40.n and outputs corresponding sensor signal input to the controller 60. It is thereby assumed that when no light is received by the light detector, a dairy animal is present in the cooling zone and has interrupted the light beam 50 by passing the head through the feed front 110. When the light detector 40.n receives light from the light emitter 30.n, the light beam 50 in uninterrupted and no dairy animal is present in the cooling zone.

The controller 60 may receive various sensor signal input from the light detector 40.n of the sensor 30.n, 40.n of each cooling zone 120.n. For example, the light detector 40.n may output a signal of a first magnitude when light from the light emitter 30.n is received by the light detector 40.n and a signal of a second magnitude when no light from the light emitter 30.n is received on the light detector 40.n. The controller 60 may thereby be configured to determine that sensor signal input from the light detector 40.n, in the form of a signal having a magnitude above a predetermined threshold value, is indicative of no presence of a dairy animal in the cooling zone 120.n. Accordingly, The controller 60 may further be configured to determine that sensor signal input from the light detector 40.n is indicative of the presence of a dairy animal in the cooling zone 120.n, e.g. the sensor signal input being a digital on/off signal indicating the presence of an animal or the sensor input signal having a magnitude above or below a predetermined threshold value, indicating the presence of an animal. In one alternative, the signal from the light detector 40.n is interrupted when the no light from the light emitter 30.n is received by the light detector 40.n. Accordingly, the controller 60 may be configured to determine that sensor signal input from the light detector 40.n in the form of no signal from the light detector 40.n is indicative of the presence of a dairy animal in the cooling zone 120.n.

The controller 60 is further configured to, based on sensor signal input from the sensor arrangement 3, 30.n, 40.n indicative of the presence of a dairy animal in a cooling zone 120.n, activate at least one cooling device 10.n, 20.n to provide cooling fluid into said cooling zone.

In the disclosed embodiment, as described above, each cooling zone 120.1-120.3 comprises one light detector 40.1-40.3 and at least one cooling device 10.1-10.3; 20.1-20.3 is provided for each cooling zone 120.1-120.3. The controller 60 is thereby configured such that the light detector 40.1-40.3 of each cooling zone 120.1-120.3 is associated with the cooling device 10.1-10.3; 20.1-20.3 of the corresponding cooling zone 120.1-120.3 such that the cooling device is activated when the presence of an animal is indicated by the corresponding light detector.

The controller 60 is further configured to receive sensor input from each of the light detectors 40.1-40.3 and, in response to sensor input indicative of the presence of a dairy animal in anyone of the cooling zones 120.1-120.3, activate the cooling devices 10.1-10.3; 20.1-20.3 of the corresponding cooling zone 120.1-120.3.

It is appreciated that the controller 60 may be configured to receive sensor signal input indicative of a dairy animal in one or more or all of the cooling zones 120.1-120.3 and in response thereto to activate the cooling devices 10.1-10.3; 20.1-20.3 in one or more or all of the corresponding cooling zones 120.1-120.3.

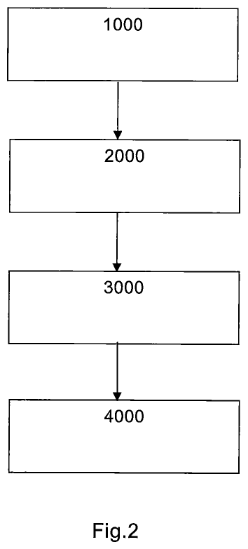

FIG. 2 shows the steps of a method for operating the cooling system 100 described above. The method may be executed in the controller 60. In a first step 1000, the sensor arrangement 3, 30.n, 40.n may sense (i.e. detect) the presence of a dairy animal in a cooling zone 120. In a second step 2000, the controller 60 receives sensor signal input from the sensor arrangement 3, 30.n, 40.n indicative of a dairy animal present in said cooling zone 120.n. In a third step 3000, the controller 60 activates, based on the sensor signal input, at least one cooling device 10.n, 20.n to provide cooling fluid into said cooling zone. The activation may comprise initiating 4000 a predetermined cooling procedure in which the controller 60 operates the cooling means 10.n, 20.n to continuously provide an air flow and simultaneously dispense cooling liquid intermittently in (short) pulses. The cooling procedure may be maintained for as long as an animal is present in the respective cooling zone, or interrupted after a predetermined time. The cooling procedure may then be repeated after a certain period of time, if an animal is detected as still being present in the cooling zone.

Although a particular embodiment of the cooling system 100 has been disclosed in detail this has been done for purpose of illustration only, and is not intended to be limiting. In particular it is contemplated that various substitutions, alterations and modifications may be made within the scope of the appended claims.

For example, the sensor arrangement 3, 30.n, 40.n for detecting the presence of a dairy animal in each cooling zone 120.n may be an imaging system 3 that comprises a camera 4 arranged to record images of the feed front (see FIG. 1) or the feeding area. The imaging system may be configured to recognize, in images obtained from the camera, the presence of a dairy animal at the feed front or in the feeding area. The camera 4, which may be a 2D- or 3D digital camera, is arranged to record images of animals or parts of the animals, including but not limited to the back or face of the animal, to detect the presence of one or more animals in the cooling zone. The camera 4 may be arranged in front of the feed front 110 opposite to the feeding area 300. Alternatively, the camera 4 may be arranged above the feed front 110 or behind the feed front, i.e. within residence area of the dairy animals 1. The camera 4 may be arranged to cover all cooling zones 120.n of the cooling system. For example the camera 4 may be provided with a wide angle lens. In this embodiment, the plurality of cooling zones 120 may be defined as a predetermined length L at a predetermined position of the feed fence. Thus, physical means for defining the cooling zones may be omitted. The imaging system may be connected to the controller 60 and the cooling zones 120 may be associated with corresponding cooling means 10, 20 as described hereinabove. In an alternative, the imaging system 3 comprises a plurality of cameras (not shown) whereby the plurality of cameras are arranged such that the plurality of cooling zones 120.n are covered by the plurality of cameras.

As described, the sensor arrangement 3, 30.n, 40.n may comprises a plurality of sensors 30.n, 40.n wherein each sensor 30.n, 40.n comprises a light detectors 40.n and light emitter 30.n. However, also other type of sensors may be provided. For example, the sensors may be mechanical sensors such as pressure plates in the floor of the feeding area 300. Other types if sensors are also feasible, for example IR sensors, ultrasonic sensors, microphones etc. It is also possible use a RTLS—Real Time Location System, where the location of the dairy animal is determined by the position of a tag that is carried by the animal in relation to fixed reference points in the dairy facility.

The cooling devices 10.n, 20.n may be realized as misting fans which dispenses a mist of cooling liquid and air onto the dairy animals 1.

1. A cooling system for cooling dairy animals at a feed front having a plurality of feeding positions for dairy animals, said cooling system comprising:
a plurality of cooling devices configured to provide cooling fluid onto dairy animals standing at the feed front;
a plurality of cooling zones, each of the cooling zones having a length along the feed front, said length corresponding to a plurality of feeding positions of the feed front, the plurality of cooling devices being configured to provide cooling fluid into the plurality of cooling zones;
a sensor arrangement configured to detect a presence of a dairy animal in at least one specific cooling zone of the plurality of cooling zones, and to output a sensor signal indicative of the presence of the dairy animal in the at least one cooling zone; and
a controller configured to control the cooling devices and to receive a sensor signal input from the sensor arrangement corresponding to the output sensor signal and, based on the sensor signal input indicative of the presence of the dairy animal in the at least one cooling zone, to activate the cooling devices to provide cooling fluid into said at least one specific cooling zone.

2. The cooling system according to claim 1, wherein the cooling devices are disposed such that cooling fluid is able to be provided into each of the cooling zones by at least one of the cooling devices.

3. The cooling system according to claim 1, wherein the sensor arrangement is configured to detect a presence of a head of the dairy animal extending through the feed front.

4. The cooling system according to claim 1, wherein the sensor arrangement comprises a plurality of sensors, each of the cooling zones comprising at least one of the sensors.

5. The cooling system according to claim 4, wherein each of the sensors comprises a light emitter disposed at one end of each of the cooling zones and a light detector disposed at another end of each of the cooling zones.

6. The cooling system according to claim 5, wherein the distance between the light emitter and the light detector defines the length of each of the cooling zones.

7. The cooling system according to claim 1, wherein the sensor arrangement is an imaging system comprising at least one camera configured to record images of one or more of the cooling zones and the feed front.

8. The cooling system according to claim 1, wherein the plurality of cooling zones are disposed adjacent to each other along the feed front.

9. A controller for controlling a plurality of cooling devices configured to provide cooling fluid into a plurality of cooling zones at a feed front, each of the cooling zones having a length along the feed front, said length corresponding to a plurality of feeding positions for dairy animals at the feed front,
wherein the controller is configured to receive a sensor signal input from a sensor arrangement, and, based on the sensor signal input indicative of a presence of one of the dairy animals in at least one specific cooling zone of the plurality of cooling zones, to output an activation signal to activate at least one of the plurality of cooling devices to provide cooling fluid into said at least one specific cooling zone.

10. A milking facility comprising;
a milking system; and
a feeding area comprising
the feed front having a plurality of feeding positions for the dairy animals, and
the cooling system according to claim 1 for cooling the dairy animals.

11. The milking facility according to claim 10, further comprising:
a resting area for the dairy animals; and
a milking area comprising the milking system configured in the milking facility such that one of the dairy animals is able to walk between the feeding area, the milking area, and the resting area during use of the milking facility.

12. The milking facility according to claim 10, wherein the milking system is an Automatic Milking System.

13. A method for operating the cooling system according to claim 1, the method comprising:
receiving the sensor signal input indicative of the presence of the dairy animal in said at least one specific cooling zone;
activating, based on the sensor signal input, the cooling devices to provide cooling fluid in said at least one specific cooling zone.

14. The method for operating the cooling system according to claim 13, further comprising:
operating the cooling devices to continuously provide an air flow and simultaneously dispense cooling liquid intermittently.

15. The cooling system according to claim 1, wherein each one of the plurality of cooling devices is dedicated to a specific one of the cooling zones.

16. The cooling system according to claim 1, wherein the sensor arrangement comprises a plurality of sensors, each of the sensors being dedicated to a specific one of the cooling zones.

17. A cooling system for cooling dairy animals at a feed front having a plurality of feeding positions for dairy animals, said cooling system comprising:
a plurality of cooling devices configured to provide cooling fluid onto dairy animals standing at the feed front;
a plurality of cooling zones, each of the cooling zones having a length along the feed front, said length corresponding to a plurality of feeding positions of the feed front, the plurality of cooling devices being configured to provide cooling fluid into the plurality of cooling zones;
a sensor arrangement comprising a plurality of sensors, each of the sensors comprising a light emitter disposed at one end of a respective cooling zone of the plurality of cooling zones and a light detector disposed at another end of the respective cooling zone, the sensors being configured to detect a presence of a dairy animal in the respective cooling zone, and to output a sensor signal indicative of the presence of the dairy animal in the respective cooling zone; and
a controller configured to control the cooling devices and to receive a sensor signal input from the sensors corresponding to the output sensor signal, and, based on the sensor signal input indicative of the presence of the dairy animal in the respective cooling zone, to activate at least one of the cooling devices to provide cooling fluid into the respective cooling zone.
